(19) United States
(12) Patent Application Publication
(10) Pub. No.: US 2017/0029692 A1
(43) Pub. Date: Feb. 2, 2017

(54) METHOD TO INCREASE THE VISCOSITY OF HYDROGELS BY CROSSLINKING A COPOLYMER IN THE PRESENCE OF DISSOLVED SALT

(71) Applicant: TouGas Oilfield Solutions GmbH, Frankfurt (DE)

(72) Inventors: Fatima Dugonjic-Bilic, Offenbach (DE); Jasmin Meurer nee Buhler, Mainz (DE); Carolin Usener, Dulmen (DE); Marita Neuber, Dreieich (DE)

(73) Assignee: TouGas Oilfield Solutions GmbH, Frankfurt am Main (DE)

(21) Appl. No.: 15/115,277

(22) PCT Filed: Jan. 30, 2014
(86) PCT No.: PCT/EP2014/000252

§ 371 Date: Jul. 29, 2016

(51) Int. Cl. C09K 8/68; E21B 43/26; C08J 3/24; C09K 8/88; C08J 3/075

(52) U.S. Cl. CPC C09K 8/685; C09K 8/887; C08J 3/075; C08J 3/24; E21B 43/26; C08J 2333/26; E21B 43/267

(57) ABSTRACT

A method for synthesize hydrogels, that may be used in fracturing operations, with increased viscosity from a solution containing water, a copolymer and a dissolved salt of an alkaline metal, an earth alkaline metal and/or an organic amine by addition of a zirconium compound as a crosslinker which comprises:
i) providing a copolymer containing structural units of formula I, structural units of formula II, and structural units of formula Ill

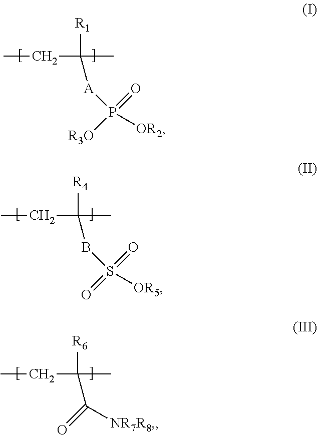

ii) preparing an aqueous solution by adding the copolymer prepared in step i) to a solution comprising water and the dissolved salt,
iii) forming a network of a hydrogel by addition of at least one zirconium-compound to the aqueous solution prepared in step ii), and
iv) selecting the amount of the dissolved salt in the hydrogel to range from 0.15 and 10 weight %.

### FIELD OF THE INVENTION

The present invention relates to a method to increase the viscosity of hydrogels and the application of the obtained hydrogels regarding the production of oil and/or gas from unconventional or highly exploited resources.

### BACKGROUND

The resources for fossil fuels are highly exploited and also limited. With new and improved technologies these resources for oil and/or gas can be further exploited and unconventional reservoirs can be accessed.

Unconventional gas reservoirs have a lower permeability than conventional ones. This is the reason why the permeability of the formation has to be improved with certain stimulation techniques (e.g. hydraulic fracturing) before an effective production of the gas can take place.

Therefore, a viscous fluid (frac fluid) is introduced into the formation with high pressure to induce cracks or fractures in the formation, to widen these cracks and to stabilize them with proppant material, like sand or ceramics.

Thus, the gas- and fluid permeability in the formation is increased and therefore oil, gas and/or water can be transported more easily to the well bore. This improves the profitability of the hydrocarbon production. Also in the field of geothermal exploration the productivity of water reservoirs can be enhanced via fracturing treatments. After the stimulation the hot rocks can efficiently be flooded with water providing an improved heat adsorption of water.

With this method also the stimulation of ground water wells can be accomplished.

Furthermore, it would be suitable in some cases to hydraulically fracture coal mine drillings for long-term pre-degassing.

In existing conventional oil and gas bearing formations, hydraulic fracturing is used to make residual amounts of liquid and gaseous fossil fuels available, which flow volume decreases due to a low permeability of the reservoir rock.

In unconventional reservoirs sufficient permeability of the rock is created by this method to specifically release natural gas from the reservoir.

During hydraulic fracturing usually horizontal wells are placed within the formation. The wellbore is set under high pressure with a frac fluid while seismically monitored in order to control the propagation of cracks via the chosen pressure. The final pressure within the formation has to be higher than the lowest internal tension in the reservoir. If this is the case the frac fluid can crack the rocks apart. After fracturing of the formation the introduced fluid, which was loaded with proppant material, will be retrieved as completely as possible. The proppant material remains in the fractures to keep them open against the surrounding rock pressure. Also some residues of the frac fluid remain due to adhesion on the liquid-solid phase boundary on the rock.

Besides the proppant material several other additives may be present in the frac fluid.

For example:
gel to increase the viscosity of the frac fluid for improved proppant transport
foam for proppant transport of the proppants, e.g. nitrogen or carbon dioxide
clay stabilizer to prevent the formation of swollen clay layers, e.g. potassium chloride, trimethylammonium chloride or choline chloride
acid for dissolution of minerals, e.g. hydrochloric acid, acetic acid, formic acid
breaker for reducing the viscosity of the frac fluid after the treatment to allow flowback of the fluid, e.g. acids, oxidizing agents and/or enzymes
biocide to prevent bacterial growth on organic compounds
fluid-loss-additives for reducing of leak-off reduction of the frac fluid in surrounding parts of the formation, e.g. natural or synthetic polymers
additives for friction reduction within the fluids, e.g. latex polymers or acrylamide based copolymers
pH buffer to provide an appropriate pH for hydration of the gelling agent and crosslinking, e.g. acetate-acetic acid buffer or borate buffer

As gels in frac fluids the below described hydrogels are applied according to the present invention.

For the production of gels with high viscosities frequently polysaccharides or modified polysaccharides are used. Common polymers based on polysaccharides are derivatives of cellulose, guar, hydroxypropyl- or carboxymethyl-derivatives of guar. Gel formation is accomplished by crosslinking of the polysaccharides. Thus, a three-dimensional network is produced within the polymer strands of the polysaccharides. The crosslinking of such polysaccharides is usually performed under alkaline conditions with borate crosslinkers.

The disadvantages of polymer gels from polysaccharides are:
long duration for hydration of polysaccharides
no complete dissolution of polymer in salty water, formation of gelled particles
limited temperature stability only up to approximately 110° C.
degradation due to microorganisms, therefore addition of biocides is necessary
degradation of polysaccharides under acidic conditions

Synthetical polymers based on acrylamide and their hydrogels distinguish themselves from unmodified and modified polysaccharide and guar derivatives with marked better temperature stability. However, the hydrogels from these polymers tend to be sensitive towards dissolved salt containing water. The viscosity of these solutions abates due to salt-polymer-interaction (see Nasr-El-Din, H. A., Hawkins, B. F. and Green, K. A., 1991. Viscosity behavior of alkaline, surfactant, polyacrylamide solutions used for enhanced oil recovery. SPE 21028, Proc. Int. Symp. Oilfield Chem., Anaheim, Calif., USA; K. C. Taylor, H. A. Nasr-El-Din, Journal of Petroleum Science and Engineering 19 (1998) 265-280; R. E. Bulo et al., ‘Site Binding’ of Ca²⁺ Ions to Polyacrylates in Water: A Molecular Dynamic Study of Coiling and Aggregation, Macromolecules 2007, 40, 3437-3442; T. Nylander et al., Formation of polyelectrolyte-surfactant complexes on surfaces, Advances in Colloid and Interface Science 2006, 123-126, 105-123; C. L. McCormick et al., Water-Soluble Copolymers, Macromolecules 1986, 19, 542-547).

Especially the high content of solubilized alkaline and alkaline earth salts may cause severe viscosity loss. Due to the presence of salt in each reservoir water this disadvantage poses a significant risk for the application of this kind of additives during the oil and gas production.

As already stated above copolymers of acrylamide are known as gel modifiers in oil and gas production

DE10 2004 035 515A1 describes a polymer which is reversibly crosslinkable with multivalent metal cations at temperatures above 150° C. The polymer is applied to alter the permeability of subterranean formations for water or saline waters. The copolymers are synthesized via radical polymerisation of 80 to 90 weight % of selected ethylenically unsaturated sulfonic acids, e.g. 2-acrylamido-2-methyl propane sulfonic acid (AMPS), 1 to 10 weight % of a N-vinylamide of a carbocylic acid, e.g. N-vinyl acetamide, 1 to 10 weight % of a selected N-vinyl-nitrogen heterocycle, e.g. N-vinylpyrrolidone, 0.1 to 5 weight % of a vinyl phosphonic acid and if applicable up to 10 weight % of an amide of an ethylenically unsaturated carbocylic acid, e.g. (meth)acrylic acid.

The enhanced temperature stability, the good gel building properties and the better stability of the gel against saline waters are ascribed to the incorporation of phosphonic acid groups, open-chain and notably cyclic vinylamides and the low content of (meth)acryl amide within the copolymer. No crosslinking of the copolymers in the presence of dissolved salt containing water is disclosed.

In WO 03/033860 A2 a procedure to minimize or to completely block the water inflow towards an oil or gas producing wellbore in subterranean formations is described. Therefore, aqueous solutions of selected copolymers together with a metal ion containing crosslinker are introduced into the wellbore. The copolymers are synthesized via radical polymerisation of 40 to 98 weight % of a selected ethylenically unsaturated sulfonic acid, e.g. AMPS, 0.1 to 58 weight % of acrylamide, 0.1 to 10 weight % of a N-vinylamide of a carboxylic acid, e.g. N-vinylacetamide, N-vinylpyrrolidone or N-vinyl caprolactam, and 0.1 to 10 weight % of vinylphosphonic acid. Adsorption on the rock of the formation, the elastic ductility and compression and the stability against salts in the formation as well as the temperature stability are ascribed to the high content of subunits from acrylamido alkylene sulfonic acids in the copolymer.

In EP 0 112 520 A2 water soluble copolymers, their reaction with multi-valent metal ions and their application for textile coloration and as retannage agents are described. Also the application of these copolymers and their metal chelate complexes as thickener for acids in oil and gas production is mentioned. The copolymers are synthesized via radical polymerisation of 1 to 86 weight % of vinylphosphonic acid, 9-80 weight % of selected (meth)acryl amides, and possibly up to 30 weight % of a N-vinylamide of a carboxylic acid, e.g. N-vinylacetamide, a vinylphosphonic acid ester and/or are crosslinked via acids. The copolymers can be crosslinked with multivalent metal cations even in diluted acidic solutions. No information is provided relating to the stability of the crosslinked polymer in saline waters.

U.S. Pat. No. 6,986,391 B2 discloses a procedure for fracturing of subterranean oil or gas deposits. Therefore, viscous aqueous solutions are pumped into the wellbore of the deposit. These solutions contain a terpolymer consisting of 55 to 65 weight % AMPS, 34.5 to 44.5 weight % acrylamide and 0.1 to 1 weight % acrylic acid, as well as a crosslinker for this terpolymer and an additive with the property to retard the degradation of the viscosity. In alternative execution forms a terpolymer is applied, which is deduced from 15 to 80 weight % AMPS, 20 to 85 weight % acrylamide and up to 10 weight % acrylic acid.

US 2012/0101229 A1 discloses modified acrylamide hydrogels for application in secondary or tertiary oil recovery. Salt-resistant and water-absorbing compounds are described which are formed via crosslinking of polyacrylamides or of di- or polysaccharides with crosslinkers from multi-valent metal cations. During generation of the hydrogels inter-penetrating networks are formed. As polyacrylamides partly hydrolysed polyacrylamides are mentioned. If needed these hydrolysed polyacrylamides can also incorporate other structural units, as for example carboxylic acid, sulfonic acid, pyrrolidone or other hydrophobic residues.

In WO 01/49971 A1 a procedure for treating of a hydrocarbon bearing formation is described where besides a hydrocarbon containing zone at least on water containing zone is present. The procedure comprises a sequential injection of an aqueous polymer solution and an aqueous crosslinker solution followed by further injection of aqueous polymer solution in a way that a collapsible gel is formed which increases the hydrocarbon production. The polymer contains 0.01 to 0.5 weight % of a crosslinkable carboxylic or phosphonic acid group and has a molecular weight of 250,000 to 12,000,000. As crosslinker salts from zirconium or titanium are used. Specific polymers are deduced from vinylphosphonic acid and (meth)acrylamide and from vinylphosphonic acid, acrylamide and (meth)acrylamide, respectively, furthermore polymers based on poly(meth)acrylamide grafted with vinylphosphonic acid are used.

U.S. Pat. No. 8,022,015 B2 discloses a method for fracturing of a subterranean formation with temperatures in the range of 149 to 260° C. To fracture the formation an aqueous treatment fluid is introduced into the well bore with the required pressure. The treatment fluid contains a copolymer deduced from AMPS, acrylamide and vinylphosphonic acid. Additionally, the treatment fluid contains multi-valent metal ions as crosslinker, phenothiazine or sodium thiosulfate as stabilizers and a buffer which keeps the pH in the range of 4.5 to 5.25. The copolymer consists of 20 to 90 weight % acrylamide, 9 to 80 weight % AMPS and 0.1 to 20 weight % vinylphosphonic acid. No information is provided relating to the stability of the crosslinked polymer in saline waters.

There is still a need for hydrogels, which are applicable in oil and/or gas production of unconventional or highly depleted deposits due to the high viscosity they deliver even in saline solutions and their high stability therein.

### SUMMARY OF THE INVENTION

Surprisingly copolymers and multivalent metal compounds were found that form hydrogels with increased viscosities in the presence of selected dissolved salts compared to their hydrogels formed in deionized, tab or surface water with no or very low content of dissolved salts under otherwise identical conditions.

### DESCRIPTION OF THE INVENTION

Therefore the present invention relates to a method to synthesize hydrogels with increased viscosity from a solution that contains water, a copolymer and a dissolved salt of an alkaline metal, an earth alkaline metal and/or an organic amine (hereinafter also called “dissolved salt”) by addition of a zirconium compound as a crosslinker which is characterized in
that the copolymer forming the network for the hydrogel contains 0.005 to 20 weight % of structural units of formula I, 4.995 to 40 weight % of structural units of formula II and 5 to 95 weight % of structural units of formula III

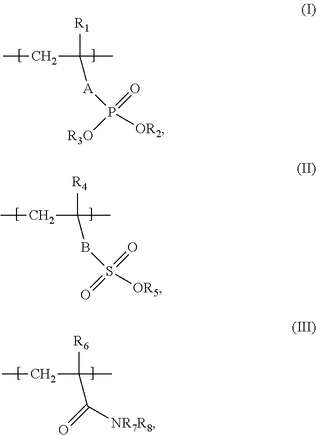

wherein
R₁, R₄ and R₆ are independently of one another hydrogen or C₁-C₆-alkyl,
R₂, R₃ and R₅ are independently of one another hydrogen, a cation of an alkaline metal, of an earth alkaline metal, of ammonia and/or of an organic amine, R₇ and R₈ are independently of one another hydrogen or C₁-C₆-alkyl,
A is a covalent C—P bond or a two-valent organic bridge group, and
B is a covalent C—S bond or a two-valent organic bridge group, and wherein the percentage of the structural units refers to the total mass of the copolymer
that the copolymer is crosslinked by Zr-compounds, e.g. by ionic or non-ionic Zr-compounds which may contain complex forming ligands
that the dissolved salt content of the hydrogel is between 0.15 and 10 weight %, referring to the total mass of the hydrogel
that the hydrogels show higher viscosities in the electrolyte containing solution than in an aqueous solution with a content of dissolved salt of less than 0.15 weight %, referring to the total mass of the hydrogel.

According to the invention the viscosity of the hydrogel formed in the presence of dissolved salt is higher than the viscosity of the hydrogel in an aqueous solution with a content of dissolved salts of less than 0.15 weight %. Therefore to achieve a desired hydrogel viscosity a lower polymer content is sufficient when using a saline solution. It is of special advantage that the dissolved salt containing solution for the preparation of the copolymer solution is solely or partly a saline water like sea water or formation water or produced water that is purified correspondingly. This is especially advantageous because in dry areas or on off-shore platforms fresh water is sparse or is not available in sufficient amounts.

According to the invention the dissolved salt in the hydrogel is present in the form of alkaline or alkaline earth metal salts. Thereby, hydroxides, sulphide, sulfites, sulphates, nitrates, phosphates and preferably halogenides, especially preferably chlorides are chosen. Sodium chloride, potassium chloride, magnesium chloride and/or calcium chloride are preferred.

Likewise, the dissolved salt in the hydrogel prepared in the method of this invention can be present as salt of organic amines, preferably as hydrochlorides of alkyl amines and of hydroxyalkyl amines, especially preferably as trimethylammonium chloride and/or choline chloride.

The dissolved salts in the hydrogel prepared in the method of this invention can stem from sea water, from formation water or from saline solutions which are admixed to the frac fluid, e.g. for clay stabilizing.

The content of dissolved salt in the hydrogel prepared in the method of this invention is preferably between 0.15 and 10 weight %, especially preferably between 0.15 and 7 weight % referred to the total mass of the hydrogel.

The copolymer used in the method of this invention comprises structural units of formulae I, II and III. Besides structural units of formulae I, II and III the copolymer used in the method of this invention may contain structural units of formula IV and/or V

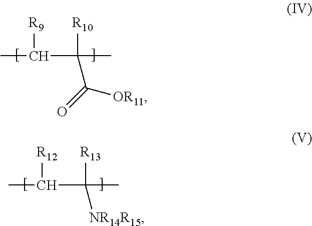

wherein
R₉, R₁₀, R₁₂ and R₁₃ are independently of one another hydrogen, C₁-C₆-alkyl, —COOR₁₆ or —CH₂—COOR₁₆, with R₁₆ being hydrogen, a cation of an alkaline metal, of an earth alkaline metal, of ammonia and/or of an organic amine,
R₁₁ is hydrogen, a cation of an alkaline metal, of an earth alkaline metal, of ammonia and/or of an organic amine, or is C₁-C₆-alkyl, a group —CₙH₂ₙ—OH with n being an integer between 2 and 6, preferably 2, or is a group —CₒH₂ₒ—NR₁₇R₁₈, with o being an integer between 2 and 6, preferably 2, and R₁₇ and R₁₈ are independently of one another hydrogen or C₁-C₆-alkyl, preferably hydrogen,
R₁₄ is hydrogen or, C₁-C₆-alkyl, and
R₁₅ is —COH, —CO—C₁-C₆-alkyl or
R₁₄ and R₁₅ together with the nitrogen atom to which they are attached form a heterocyclic group with 4 to 6 ring atoms, preferably a pyridine ring, a pyrrolidone ring or a caprolactame ring,
and wherein the percentage of the structural units IV and/or V refers to the total mass of the copolymer.

C₁-C₆-alkyl groups may be straight-chain or branched. Examples of alkyl groups are methyl, ethyl, n-propyl, iso-propyl, n-butyl, sec.-butyl, tert.-butyl, n-pentyl or n-hexyl. Ethyl and especially methyl are preferred.

Group A may be a C—P-covalent bond or a two-valent organic group. Examples thereof are C₁-C₆-alkylene groups. These groups may be straight-chain or branched. Examples of alkylene groups are —C_{q}H_{2q}— groups, with q being an integer between 1 and 6. Methylene or a C—P-covalent bond is a preferred group A.

Group B may be a C—S-covalent bond or a two-valent organic group. Examples thereof are C₁-C₆-alkylene groups or —CO—C₁-C₆-alkylene groups. The alkyl groups may be straight-chain or branched. Examples of B groups are —C_{q}H_{2q}— groups or —CO—NH—C_{q}H_{2q}— groups, with q being an integer between 1 and 6. —CO—NH—C(CH₃)₂—CH₂— or a C—S-covalent bond is a preferred group B.

The structural units of formulae I, II and III are derived from at least an ethylenically unsaturated phosphonic acid, an ethylenically unsaturated carboxylic acid amide selected from the group of acrylamide, methacrylamide and/or their N—C₁-C₆-alkyl derivatives, an ethylenically unsaturated sulfonic acid and/or their alkaline metal salts and/or their ammonium salts optionally together with further copolymerisable monomers forming the structural units of formulae IV and/or V.

Preferred copolymers used in the method of this invention are those, wherein R₁, R₄ and R₆ are independently of one another hydrogen or methyl or wherein R₂, R₃ and R₅ are independently of one another hydrogen or a cation of an alkali metal, of an earth alkaline metal, of ammonia or of an organic amine or wherein R₇ and R₈ are independently of one another hydrogen, methyl or ethyl, preferably hydrogen.

Other preferred copolymers used in the method of this invention are those, wherein A is a C—P covalent bond or a —CₙH₂ₙ— group with n being an integer between 1 and 6, preferably 1, or wherein B is a C—S covalent bond or a —CO—NH—CₘH₂ₘ— group with m being an integer between 1 and 6, preferably between 2 and 4, B being most preferably a group —CO—NH—C(CH₃)₂—CH₂—.

Still other preferred copolymers used in the method of this invention are those, wherein R₉ is hydrogen and R₁₀ is hydrogen or methyl, or wherein R₉ is —COOR₁₆ and R₁₀ is hydrogen or wherein R₉ is hydrogen and R₁₀ is —CH₂—COOR₁₆ or wherein R₁₂ is hydrogen and R₁₃ is hydrogen or methyl, or wherein R₁₂ is —COOR₁₆ and R₁₃ is hydrogen or wherein R₁₂ is hydrogen and R₁₃ is —CH₂—COOR₁₆.

Preferably applied are copolymers with structural units derived from vinylphosphonic acid and/or its alkaline metal salts and/or its ammonium salts, and/or allylphosphonic acid and/or its alkaline metal salts and/or its ammonium salts.

The copolymers comprise structural units derived from acrylamide, from methacrylamide and/or from their N—C₁-C₆-alkyl derivatives.

Also preferably applied are copolymers with structural units derived from vinylsulfonic acid, 2-acrylamido-2-methylpropane sulfonic acid, 2-methacrylamido-2-methylpropane sulfonic acid, styrene sulfonic acid and/or their alkaline metal salts and/or their ammonium salts. Especially preferred are structural units derived from 2-acrylamido-2-methylpropane sulfonic acid and/or from 2-methacrylamido-2-methylpropane sulfonic acid and/or from their alkaline metal salts and/or from their ammonium salts.

The further copolymerizable monomers which are optionally used in the manufacture of the copolymers are chosen from ethylenically unsaturated carboxylic acid and/or from additional copolymerisable monomers. The latter are preferably chosen from the group of alkylesters from ethylenically unsaturated carboxylic acid, oxyalkylesters of ethylenically unsaturated carboxylic acid, esters of ethylenically unsaturated carboxylic acids with N-dialkylalkanolamines and/or from N-vinylamides.

The ethylenically unsaturated carboxylic acids are preferably acrylic acid, methacrylic acid, fumaric acid, maleic acid, itaconic acid and/or crotonic acid as well as their alkaline metal salts and/or their ammonium salts. The alkylesters of ethylenically unsaturated carboxylic acids are preferably alkylesters of acrylic acid, methacrylic acid, fumaric acid, maleic acid, itaconic acid and/or crotonic acid. Especially preferred are alkylesters with 1 to 6 carbon atoms.

The oxyalkylesters of an ethylenically unsaturated carboxylic acid are preferably 2-hydroxyethylester of acrylic acid, methacrylic acid, fumaric acid, maleic acid, itaconic acid and/or crotonic acid.

The ester of ethylenically unsaturated carboxylic acid with N-dialkylalkanolamine is preferably N,N-dimethylethanolamine methacrylate, its salt or quaternary ammonium product.

The N-vinylamide is preferably N-vinylformamide, N-vinylacetamide, N-vinyl-N-methylacetamide, or N-vinylamide comprising cyclic N-vinylamide groups, preferably derived from N-vinylpyrrolidone, N-vinylcaprolactam or N-vinylpyridine.

The copolymer used in the method of this invention is characterized by adequate formation of hydrogels via treatment with a crosslinker comprising multivalent zirconium ions especially in the presence of saline solutions respectively a saline environment even at high temperatures. The formed hydrogel can be applied as frac fluid and features the necessary properties, as elasticity, viscosity and pseudoplastic behaviour.

These properties distinguish the hydrogel prepared with the method of this invention from hydrogels consisting of synthetic copolymers which are indeed structurally similar but which have been prepared by other methods.

As a result the hydrogels prepared with the method of this invention show an even higher stability under saline conditions than in fresh water under the applied conditions and even at higher temperatures, whereas hydrogels from other polymers are not applicable under these conditions because of denaturation and loss of viscosity so that no stable hydrogel is built up. It is believed that the phosphonic acid moieties are the reason for the high stability of the crosslinking with zirconium ions.

The amount of structural units of formula I derived from ethylenically unsaturated phosphonic acid in the copolymer used in this invention is typically in the range of 0.005 to 20 weight %, preferably from 0.05 to 5 weight %, referred to the total mass of the copolymer.

The amount of structural units of formula III derived from an amide of an ethylenically unsaturated carboxylic acid in the copolymer used in this invention is typically in the range of 5 to 95 weight %, preferably from 10 to 50 weight %, referred to the total mass of copolymer.

The amount of structural units of formula II derived from an ethylenically unsaturated sulfonic acid in the copolymer used in this invention is typically in the range of 5 to 40 weight %, preferably from 10 to 30 weight %, referred to the total mass of copolymer.

The amount of structural units derived from other comonomers, so from other comonomers than ethylenically unsaturated phosphonic acid, amides of ethylenically unsaturated carboxylic acid and ethylenically unsaturated sulfonic acids in the copolymer used in the method of this invention are typically not higher than 20 weight %, preferably not higher than 15 weight %, referred to the total mass of copolymer.

The copolymers used in the invention can be synthesized via different radical polymerisation techniques, e.g. solution polymerisation, gel polymerisation, and particularly inverse emulsion polymerisation. The advantage of inverse emulsion polymerisation is the high molecular weight of the obtained copolymer. Further, the polymer which is present in the inverse emulsion can be hydrated very fast which leads to a fast increase in viscosity when putting the polymer into water. According to the invention the inventive polymer is preferably synthesized via inverse emulsion polymerisation.

The polymerisable monomers can normally be used in commercial quality, so without further purification. The copolymers used in the invention are synthesized in a per se known procedure, e.g. gel polymerisation, solution polymerisation and preferably inverse emulsion polymerisation, in a way that the monomers to be polymerized are subjected to a radical copolymerisation.

As part of this description radical copolymerisation means that at least three monomers, which are capable of being radically polymerized with each other, are polymerised under the conditions of a radical copolymerisation. Thus, copolymers with statistical or alternating distribution of the structural units derived from the at least three monomers, or block-copolymers where blocks from the particular monomers are build up and are covalently linked to each other, are obtained.

The process of inverse emulsion polymerisation is known. In this preferred polymerization process first an aqueous or water-miscible hydrophilic phase containing the monomers is finely dispersed in a water-immiscible organic phase containing water-in-oil emulsifiers and then the polymerization is started by e.g. radical initiators.

The comonomers to be polymerised are advantageously dissolved subsequently in the hydrophilic phase. Where applicable, solid monomers can be dissolved in liquid monomers. The comonomers can form the hydrophilic phase by itself and be emulsified as such in the water-immiscible organic phase or preferred the comonomers are dissolved in water and are emulsified as an aqueous solution. Water insoluble or slightly soluble monomers are normally dissolved in the hydrophobic liquid before addition of the aqueous solution. As part of this description “water soluble” means that 1 g substance is soluble in 1 liter water at 25° C.

The hydrophilic phase contains from 10 to 100 weight % comonomers and from 0 to 90 weight % water referred to the total mass of the hydrophilic phase. The preferred process of inverse emulsion polymerisation is typically performed in a 20 to 60 weight % aqueous solution of monomers (referred to the total mass of the aqueous phase).

As hydrophobic liquid a water insoluble, inert liquid is used. Such liquids are e.g. organic solvents, preferably hydrocarbons as e.g. cyclohexane, n-pentane, n-hexane, n-heptane, i-octane, technical mixtures of hydrocarbons, toluene, xylene, halogenated hydrocarbons as e.g. chlorobenzene, o-dichloro-benzene. Also mixtures of different organic solvents are applicable.

To emulsify the monomer phase in the water-immiscible organic phase to give a water in oil emulsion, a lipophilic surfactant that prevents the finely divided aqueous layer from coalescence is typically dissolved in the applied hydrophobic liquid and. Suitable lipophilic surfactants are organic substances with a low HLB-value, as e.g. sorbitane esters, sorbitane oleates or sorbitane stearates, or ethoxylated fatty amides, glycerine fatty acid esters as glycerine oleate or diacetyl tartaric acid ester of fatty acid glycerides, poly siloxanes or polyalkylene glycols. In the preferred process of inverse emulsion polymerisation the HLB-value of the lipophilic surfactants is less than 10.

The lipophilic surfactant or a mixture of different lipophilic surfactants are typically used in amounts from 0.05 to 15 weight %, preferably, 0.1 to 10 weight %, referred to the total mass of the formulation.

The volumes of the hydrophobic and hydrophobic phases are typically in a ratio of 0.5-10:1.

The dispersion of the hydrophilic comonomer containing solution into the lipophilic surfactant containing hydrophobic solution is performed in conventional style, preferably via vigorous stirring. It is beneficial to perform the copolymerisation under exclusion of oxygen. This is ensured via passing of inert gas, e.g. nitrogen, through the reaction mixture.

The copolymerisation is started in a manner known per se, e.g. UV-light, high energy radiation, typically by addition of a mixture of soluble, radical producing initiators to the water-in-oil emulsion. Suitable initiators are organic or inorganic per- and azo-compounds, e.g. benzoyl peroxide, tert-butyl hydroperoxide, cymol peroxide, methyl ethyl ketone peroxide, lauroyl peroxide, tert-butyl perbenzoate, tert-butyldiperphthtalate, azodiisobutyronitrile, 2,2′-azo-bis(2,3-dimethylvaleronitrile), 2-phenyl-azo-2,4-dimethyl-4-methoxy-valeronitrile, 2-cyano-2-propyl-azoformamide, azo-diisobutyramide, dimethyl-, diethyl- or dibutyl-azo-bis-methylvalerate, potassium persulfate, ammonium persulfate, hydrogen peroxide.

Referred to the total mass of monomers preferably 0.001 to 2 weight-%, especially preferably 0.01 to 0.1 weight-%, initiator are used. The radical initiator or the mixture of different radical initiators can be added to the hydrophilic and/or to the hydrophobic phase or to the emulsion.

The polymerisation reaction is carried out in a temperature range from −20° C. to 200° C., preferred from 10 to 90° C. The applied pressure is typically atmospheric pressure in case the boiling point of either the aqueous phase or the organic phase is not reached at the chosen temperature. If the boiling point of either the hydrophilic phase or the organic phase is higher than the polymerization temperature an elevated pressure is applied to avoid boiling. In any case, the polymerisation can be carried out at elevated pressure if desired.

The copolymerisation is typically finished after 0.3 to 3 h. After completion of the copolymerisation the copolymer is present as dispersion in a water-in-oil phase.

The finished water-in-oil dispersion typically consists of 20 to 90 weight-% aqueous phase, referred to the total mass of the formulation. The aqueous phase contains basically the complete copolymer, having typically a concentration in the range of 20 to 60 weight-%, referred to the total mass of the aqueous phase. The continuous hydrophobic phase of the water-in-oil polymer dispersion, namely the liquid hydrocarbon solution and the lipophilic surfactants are typically present in the range of 10 to 80 weight-%, referred to the total mass of the formulation.

The copolymerisation can also be performed as gel polymerisation. With this technique typically 5 to 60 weight-% of monomers (referred to the total mass of the mixture) are polymerised in water or a solvent mixture from water and another completely water miscible solvent, e.g. alcohol, using known suitable catalyst system without mechanically mixing of the solution under utilization of the Tromsdorff-Norrisch-effect (Rios Final Rep. 363, 22; 35 Makromol. Chem. 1947, 1, 169).

The gel polymerisation is beneficially performed under exclusion of oxygen, e.g. in an inert atmosphere with nitrogen at temperatures from −20° C. to 200° C., preferred from 10 to 90° C. The applied pressure is typically atmospheric pressure in case the boiling point of the mixture is not reached at the chosen temperature. In any case the polymerisation can be carried out at elevated pressure if desired.

The copolymerisation can be initiated by high energy radiation or typically by addition of a mixture of soluble, radical producing initiators, for example organic or inorganic per- and azo-compounds, e.g. benzoyl peroxide, tert-butyl hydroperoxide, cymol peroxide, methyl ethyl ketone peroxide, lauroyl peroxide, tert-butyl perbenzoate, tert-butyldiperphthtalate, azodiisobutyronitrile, 2,2′-azo-bis(2,3-dimethylvaleronitrile), 2-phenyl-azo-2,4-dimethyl-4-methoxy-valeronitrile, 2-cyano-2-propyl-azoformamide, azo-diisobutyramide, dimethyl-, diethyl- or dibutyl-azo-bis-methylvalerate, potassium persulfate, ammonium persulfate, hydrogen peroxide if appropriate in combination with reducing agents, e.g sodium bisulfite and iron (II) sulfate, or redox systems which have for example sulfinic acid as reducing compound. As a rule 0.001 to 2 g of the polymerisation initiator per 100 g of monomers are used.

The copolymers synthesized by gel polymerisation to be applied for the hydrogels according to this invention are present in the form of an aqueous gelatinous mass and can be mechanically grinded and dried and therefore be obtained in solid form. Preferably the aqueous gelatinous mass is directly applied.

For application of copolymers in water-in-oil dispersions, respectively of copolymers obtained from gel or solution polymerisation, in frac fluids for hydraulical fracturing of oil and gas bearing formations diluted solutions are required.

For dilution the inverse polymer emulsion is mixed with water or an aqueous solution containing dissolved salt in a way that the micelles are destroyed and the copolymer is released from the micelles. For breaking of the emulsion sufficient mechanical energy is introduced via stirring or a suitable surfactant featuring a HLB>10 is added to the diluting water or aqueous electrolyte solution. This process is called inversion. In the presence of a suitable surfactant the inversion is complete within a very short period of time, e.g. some seconds, without building of agglomerates.

The copolymers from gel or solution polymerisation are put into water or aqueous solution containing dissolved salt for dilution. These copolymers dissolve only very slowly. The higher the polymer content of the admixed powder, gel or solution, the longer it takes for complete dissolution.

It is a distinct application advantage if the dilution process occurs fast and if homogenous polymer solutions can be obtained. Especially preferred are therefore hydrogels derived from synthetic copolymers which are synthesized via inverse emulsion polymerisation.

The lower the content of dissolved salts in a solution, the faster the copolymers are dissolved in this solution. It is therefore sometimes beneficial to first to dissolve the copolymer in deionized water or in dissolved salt containing water with a lower content of dissolved salt in a higher concentration than needed and afterwards to add to this copolymer solution a dissolved salt containing solution with a high content of dissolved salt to finally obtain the desired dissolved salt and copolymer concentration.

The average molecular weight of the copolymers used in the method of the present invention can vary in a broad range. Hydrogels derived from synthetical copolymers with a high molecular weight are preferred.

The average molecular weight can be determined via gel permeation chromatography (GPC). Commercially available polymers, e.g. from acrylamide with molecular weight of 1,140,000 Dalton and 5,550,000 Dalton can be used as standards. For separation of the sample a column consisting of a polyhydroxymethacrylate copolymer network with a pore volume of 30,000 Å can be used. Typically, the weight average molecular weights of the copolymers used in the method of the present invention are in the range from 10,000 to 25,000,000 Dalton (g/mol), preferably between 1,000,000 and 10,000,000 Dalton.

Especially preferred for the preparation of the hydrogel according to the method of the present invention are copolymers with a weight average molecular weight of at least 500,000 Dalton, most preferred of at least 1,000,000 Dalton.

The electrolyte containing hydrogel obtained with the method of the present invention in general has a concentration of copolymer from 0.1 to 10 weight %, preferably from 0.1 to 2.5 weight %, especially preferably from 0.2 to 1.5 weight %, referred to the total mass of the hydrogel.

The hydrogel is obtained by the method of the present invention via crosslinking the copolymer with the above-mentioned zirconium compounds. Water soluble salts of zirconium cations can be used, e.g. hydroxides, sulfates and especially halogenides as for example chlorides. Further applicable zirconium salts are those with organic anions and/or their combinations, e.g. lactate, citrate, gluconate or tartrate. Also applicable are complexes of zirconium cations with organic O- and/or N-containing compounds, e.g. complexes of zirconium cations with alcohols, carboxylic acids, dicarboxylic acids, amines, diamines or hydroxylalkylamines, also in combination with organic and/or inorganic anions. Salts and/or complexes of zirconium cations can be present in water and/or in a water miscible solvent.

Preferred are zirconium cations with organic anions and zirconium complexes with organic O- and/or N-containing compounds or combinations thereof. Zirconium compounds suitable as crosslinkers can easily be synthesized starting from e.g. tetra-n-propyl-zirconate that is commercially available. Complex building compounds are than added to the tetra-n-propyl-zirconate often in diluted solution in n- or i-propanol and stirred at ambient temperature. Detailed descriptions can be found for example in U.S. Pat. No. 4,883,605, U.S. Pat. No. 7,795,189, or US 2007/0187101. Various zirconium complexes for crosslinking of polymers especially for the application in frac fluids are also commercially available e.g. from Dorf Ketal under the brand name “Tyzor®”.

For preparation of the hydrogels the zirconium compounds, e.g. the salts and/or complexes of zirconium cations, dissolved and/or diluted in water or in a water miscible solvent, are added with stirring to the solution containing dissolved salt and copolymer to ensure a homogenous distribution of zirconium cations in the solution. The three-dimensional polymer network is formed, the initial solution is becoming viscous and the hydrogel is formed. The hydrogel formation can be speeded up by adaptation of the stirring speed, pH value and/or temperature increase.

The molar concentration of zirconium cations needed for crosslinking is referred to the amount of monomers with acidic side chains, which had been introduced during copolymerisation, whereas from the monomer composition the amount of substance of acid group containing monomers is calculated in mol. Typically, from 10⁻⁵ to 100 mol zirconium per mol monomer with acidic groups, preferably 10⁻³ to 2 mol/mol, especially preferably 0.01 to 1 mol/mol are used.

The hydrogel prepared according to the method of the present invention shows as markedly high stability. This means, the hydrogel does not experience a significant degradation in the formation and that the pressure induced in the formation from the proppant containing hydrogel can last for a long time, if desired. It is of special advantage that the viscosity of the hydrogel is higher when the gel is prepared with dissolved salt containing water compared to the hydrogel made from deionized water or from tab water. To achieve a desired viscosity the copolymer content can be reduced in the presence of salts. It is of further advantage that formation water or sea water or even produced water after a purification can be used to provide the preferred electrolyte concentration.

For the purpose of this patent description the viscosity and the stability of the hydrogel is characterized as follows:

The prepared hydrogel is heated to the desired temperature and its viscosity is determined at the respective temperature with a defined shear rate and, if necessary with variation of the shear rate in a rheometer. At elevated temperatures application of nitrogen pressure on the hydrogel prevents boiling of the aqueous hydrogel composition. The variation of viscosity as a function of time and, if applicable, shear rate is monitored and judged.

The hydrogel prepared according to the method of this invention is generally applied at temperatures between 40 and 230° C., preferred between 50 and 200° C. and most preferred between 50 and 160° C.

The present invention also relates to a method for hydraulic fracturing of a formation to increase its permeability for improved production of oil and/or gas and/or water, wherein the electrolyte containing hydrogel described above is used as a thickener and ensures an effective transport of proppant material into the fractured formation.

A preferred method for preparation of the hydrogel is characterized by the production of a solution of copolymers in electrolyte containing water, either via stirring of an aqueous solution of gelatinous mass from gel polymerization or from solution polymerisation, or via inversion of an inverse polymer emulsion, by introduction of a zirconium salt or zirconium complex into this solution and, optionally, by introduction of a buffer into this solution before introducing the obtained formulation into the wellbore, so that the copolymer can build up a three dimensional network, and optionally by addition of further additives and proppants to the formulation and by injecting of the formulation into the wellbore.

A further preferred method for the preparation of the hydrogel is characterized by the production in a first step of an aqueous solution of the copolymer in a higher concentration as needed in the final hydrogel product which comprises no dissolved salt or a low content of dissolved salt and by adding to this solution in a second step an aqueous solution comprising dissolved salt in a higher concentration so that the desired concentrations of copolymer and dissolved salt are obtained and crosslinking the copolymer by adding a Zr-compound to the solution to form the final hydrogel product.

Especially preferred is a method where the aqueous and dissolved salt containing solution for the preparation of the copolymer solution is solely or partly a saline water like sea water or formation water or produced water that is purified correspondingly. This is especially advantageous because in arid regions or on off-shore platforms where fresh water is sparse or is not available in sufficient amounts.

The invention relates also to the use of a zirconium compound to increase the viscosity of hydrogels comprising water, a dissolved salt selected from the group comprising alkaline metal salt, earth alkaline metal salt and/or salt of organic amine and an ionically crosslinked synthetic copolymer by addition of the zirconium compound during the gelation process of the synthetic copolymer, wherein the copolymer contains structural units derived from copolymerisation of at least 0.005 to 20 weight % of an ethylenically unsaturated phosphonic acid, 4.995 to 50 weight % of an ethylenically unsaturated sulfonic acid and 5 to 95 weight % of an amide of an ethylenically unsaturated carboxylic acid, where the percentage refers to the total mass of the monomers used during copolymerisation.

The following examples illustrate the invention without limiting it.

### Example 1

### Preparation of Copolymer 1

37 g sorbitan monooleate were dissolved in 160 g C₁₁-C₁₆ isoparaffin. 100 g water in a beaker were cooled to 5° C., then 50 g 2-acrylamido-2-methylpropane sulfonic acid and 10 g vinylphosphonic acid were added. The pH was adjusted to 7.1 with aqueous ammonia solution. Subsequently 223 g acryl amide solution (60 weight % in water) were added.

Under vigorous stirring the aqueous monomer solution was added to the isoparaffin mixture. The emulsion was then purged for 45 min with nitrogen.

The polymerization was started by addition of 0.5 g azoisobutyronitrile in 12 g isoparaffin and heated to 50° C. To complete the reaction the temperature was increased to 80° C. and maintained at this temperature for 2 h. The polymer emulsion was cooled to room temperature and further processed.

### Example 2

### Preparation of Copolymer 2 (Comparative, No Phosphonic Acid Groups)

The polymerization was carried out as described in example 1, however the polymer composition was 50 g 2-acrylamido-2-methylpropane sulfonic acid, 10 g acrylic acid and 223 g acryl amide solution (60 weight % in water).

Copolymer 2 was synthesized to demonstrate that the preparation of the hydrogel with increased viscosity in dissolved salt containing solution is mainly ascribed to the interactions of the crosslinker with the phosphonic acid groups. In the presence of dissolved salts only copolymers containing phosphonic acid groups can form stable hydrogels.

### Example 3

### Crosslinking of Copolymer 2 (Comparative)

1 g Isotridecanethoxylate (6 EO) was dissolved in 199 g water in a Waring blender. Then 0.24 g sodium thiosulfate were added. 3.23 g of the polymer emulsion obtained according to example 2 were injected into the vortex of the prepared solution. The mixture was stirred for 4 min, then 1 g acetic acid and 1.04 g zirconium (IV)-triethanolamine solution (25 weight % in water) were added. The gel was stirred for another minute.

The gel was filled into a nitrogen purged, cylindrical rheometer pressure cell and closed. To prevent boiling at higher temperatures the pressure in the cell was adjusted to 50 bar with nitrogen.

The gel was heated to 65° C. and a shear rate of 100 s⁻¹ was applied. After 1 h a viscosity of 400 mPas was recorded.

### Example 4

### Comparative

1 g Isotridecanethoxylate (6 EO) was dissolved in 197 g water in a Waring blender. Then 0.24 g sodium thiosulfate and 2 g potassium chloride were added. 3.23 g of the copolymer emulsion obtained according to example 2 were injected into the vortex of the prepared solution. The mixture was stirred for 4 min, then 1 g acetic acid and 1.04 g zirconium (IV)-triethanolamine solution (25 weight % in water) were added. The gel was stirred for another minute.

The gel was characterized in a rheometer according to the procedure described in example 3. After 1 h a viscosity of 55 mPas was obtained.

This result clearly shows that the copolymer synthesized according to example 2 is very sensitive against dissolved salt containing water and does not form a hydrogel at all.

### Examples 5 to 15

Copolymers of examples 1 were crosslinked according to the procedure of example 3. Different commercially available zirconium crosslinkers were used to build the hydrogel. Additionally the type and the concentration of salts dissolved in the water were varied. A reference example was performed for each test condition without additional dissolved salts.

The hydrogels were characterized in a rheometer according to the procedure described in example 3. The temperature and period of the measurement were varied.

The viscosities of the hydrogels are listed in Table 1.

TABLE 1

| | | | | Copolymer | | Dissolved salt | | |
|---|---|---|---|---|---|---|---|---|
| | | | | concentation | | concentration | Time of | |
| | Crosslinker | Temp. | | in hydrogel | Dissolved | in hydrogel | measure- | Viscosity, |
| Ex. | type | ° C. | Copolymer | weight % | salt | weight % | ment, h | mPas |
| 3 | Tyzor ® | 65 | Example 2 | 0.45 | — | | 1 | 400 |
| | TEAZ | | | | | | | |
| 4 | Tyzor ® | 65 | Example 2 | 0.45 | KCl | 1.0 | 1 | 55 |
| | TEAZ | | | | | | | |
| 5 | Tyzor ® | 65 | Example 1 | 0.45 | — | | 1 | 500 |
| | TEAZ | | | | | | | |
| 6 | Tyzor ® | 65 | Example 1 | 0.45 | KCl | 1.0 | 1 | 1400 |
| | TEAZ | | | | | | | |
| 7 | Tyzor ® 223 | 160 | Example 1 | 0.6 | — | | 0.5 | 1600 |
| 8 | Tyzor ® 223 | 160 | Example 1 | 0.6 | KCl | 2.0 | 0.5 | 1800 |
| 9 | Tyzor ® 223 | 160 | Example 1 | 0.6 | NaCl | 3.0 | 0.5 | 1700 |
| | | | | | CaCl₂ | 0.3 | | |
| 10 | Tyzor ® 227 | 82 | Example 1 | 0.6 | — | | 1 | 2300 |
| 11 | Tyzor ® 227 | 82 | Example 1 | 0.6 | KCl | 2.0 | 1 | 2400 |
| 12 | Tyzor ® 223 | 90 | Example 1 | 0.6 | — | | 0.5 | 400 |
| 13 | Tyzor ® 223 | 90 | Example 1 | 0.6 | CaCl₂ | 4.06 | 0.5 | 700 |
| | | | | | NaCl | 2.49 | | |
| | | | | | KCl | 0.03 | | |
| | | | | | MgCl₂ | 0.02 | | |
| | | | | | BaCl₂ | 0.03 | | |
| 14 | Tyzor ® 223 | 72 | Example 1 | 0.45 | — | | 1 | 200 |
| 15 | Tyzor ® 223 | 72 | Example 1 | 0.45 | CaCl₂ | 2.9 | 1 | 1300 |
| | | | | | NaCl | 0.6 | | |

From examples 5 and 6 it is obvious that the presence of phosphonic acid groups in the copolymer results in a more viscous hydrogel when the gel is prepared in the presence of 1% potassium chloride.

In examples 7 to 9 is shown that the increase in viscosity of the hydrogel due to the addition of electrolyte also works at extremely high temperatures.

Example 13 demonstrates that also extremely high concentrations of divalent cations do not disturb the gel formation but increase the viscosity of the hydrogel compared to the hydrogel made without the addition of electrolytes as shown in example 12.

In example 15 it is illustrated that even at low copolymer concentration a significant increase in the hydrogel viscosity can be achieved, compared to example 14, when a moderate concentration of divalent electrolytes according to the method of the present invention is added to the formulation.

1. A method for synthesizing hydrogels with increased viscosity from a solution containing water, a copolymer, and a dissolved salt of an alkaline metal, an earth alkaline metal and/or an organic amine, by addition of a zirconium compound, as a crosslinker, comprises the steps of:
i) providing a copolymer containing 0.005 to 20 weight % of structural units of formula I, 4.995 to 40 weight % of structural units of formula II, and 5 to 95 weight % of structural units of formula III 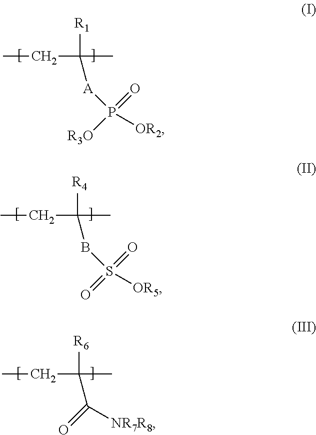
wherein
R₁, R₄ and R₆ are independently of one another hydrogen or C₁-C₆-alkyl,
R₂, R₃ and R₅ are independently of one another hydrogen, a cation of an alkaline metal, of an earth alkaline metal, of ammonia and/or of an organic amine, R₇ and R₈ are independently of one another hydrogen or C₁-C₆-alkyl,
A is a covalent C—P bond or a two-valent organic bridge group, and
B is a covalent C—S bond or a two-valent organic bridge group, and wherein the percentage of the structural units refers to the total mass of the copolymer;
ii) preparing an aqueous solution by adding the copolymer prepared in step i) to a solution comprising water and the salt of the alkaline metal, the earth alkaline metal and/or the organic amine;
iii) forming a hydrogel by addition of at least one zirconium-compound to the aqueous solution prepared in step ii); and
iv) selecting the amount of the salt of the alkaline metal, the earth alkaline metal and/or the organic amine in the hydrogel to range from 0.15 and 10 weight %, referring to the total mass of the hydrogel.

2. The method of claim 1, wherein the concentration of the alkali metal salt, the earth alkali metal salt and/or the ammonium salt in the hydrogel is between 0.5 and 5 weight %, referring to the total mass of the hydrogel.

3. The method of claim 1, wherein the alkali metal salt and/or earth alkali metal salt is a hydroxide, sulphide, sulfite, sulphate, nitrate, phosphate and/or a halogenide.

4. The method of claim 3, wherein the alkali metal salt or the earth alkali metal salt is selected from the group comprising sodium chloride, potassium chloride, magnesium chloride and/or calcium chloride.

5. The method of claim 1, wherein the solution containing water and the dissolved salt of an alkaline metal and/or an earth alkaline metal is sea water, formation water or a produced water.

6. The method of claim 1, wherein the salt of the organic amine is selected from the group of hydrochlorides of alkyl amines and hydroxyalkyl amines.

7. The method of claim 1, wherein the concentration of the copolymer is between 0.1 and 10 weight %, referring to the total mass of the hydrogel.

8. The method of claim 1, wherein R₁, R₄ and R₆ are independently of one another hydrogen or methyl or wherein R₂, R₃ and R₆ are independently of one another hydrogen or a cation of an alkali metal, of an earth alkaline metal, of ammonia or of an organic amine or wherein R₇ and R₈ are independently of one another hydrogen, methyl or ethyl, preferably hydrogen.

9. The method of claim 1, wherein A is a C—P covalent bond or a —CₙH₂ₙ— group with n being an integer between 1 and 6, or wherein B is a C—S covalent bond or a —CO—NH—CₘH₂ₘ— group with m being an integer between 1 and.

10. The method of claim 1, wherein the copolymer additionally contains up to 20 weight % of structural units of formula IV and/or V 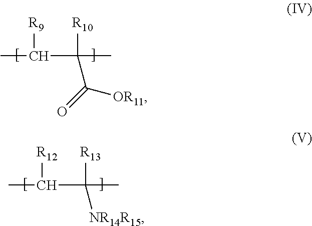
wherein
R₉, R₁₀, R₁₂ and R₁₃ are independently of one another hydrogen, C₁-C₆-alkyl, —COOR₁₆ or —CH₂—COOR₁₆, with R₁₆ being hydrogen, a cation of an alkaline metal, of an earth alkaline metal, of ammonia and/or of an organic amine,
R₁₁ is hydrogen, a cation of an alkaline metal, of an earth alkaline metal, of ammonia and/or of an organic amine, or is C₁-C₆-alkyl, a group —CₙH₂ₙ—OH with n being an integer between 2 and 6, preferably 2, or is a group —CₒH₂ₒ—NR₁₇R₁₈, with o being an integer between 2 and 6, preferably 2, and R₁₇ and R₁₈ are independently of one another hydrogen or C₁-C₆-alkyl, preferably hydrogen,
R₁₄ is hydrogen or C₁-C₆-alkyl,
R₁₅ is —COH or —CO—C₁-C₆-alkyl or
R₁₄ and R₁₅ together with the nitrogen atom to which they are attached form a heterocyclic group with 4 to 6 ring atoms, preferably a pyridine ring, a pyrrolidone ring or a caprolactame ring, and
wherein the percentage of the structural units IV and/or V refers to the total mass of the copolymer.

11. The method of claim 10, wherein R₉ is hydrogen and R₁₀ is hydrogen or methyl, or wherein R₉ is —COOR₁₆ and R₁₀ is hydrogen or wherein R₉ is hydrogen and R₁₀ is —CH₂—COOR₁₆ or wherein R₁₂ is hydrogen and R₁₃ is hydrogen or methyl, or wherein R₁₂ is —COOR₁₆ and R₁₃ is hydrogen or wherein R₁₂ is hydrogen and R₁₃ is —CH₂—COOR₁₆.

12. The method of claim 1, wherein the synthetic copolymer is synthesized by inverse emulsion polymerization or by gel polymerization.

13. The method of claim 1, wherein the synthetic copolymer for forming a hydrogel has a weight average molecular weight of at least 500,000 Dalton.

14. The method of claim 1, wherein the copolymer is ionically crosslinked with zirconium cations from zirconium salts or with zirconium complexes whereby the zirconium salts or the zirconium complexes are applied as a solution in water or as a solution in solvents miscible with water.

15. The method of claim 14, wherein the anions of the zirconium salt are chosen from the group of anorganic anions.

16. The method of claim 14, wherein the zirconium complex comprises zirconium cations and organic compounds comprising O- and/or N-atoms.

17. The method of claim 1, wherein the temperature for the application of the hydrogel is between 40 and 230° C.

18. A method for hydraulic fracturing of oil- and gas reservoirs or for stimulation of underground water reservoirs by injecting a hydrogel into the reservoir or by forming a hydrogel within the reservoir comprising that a method to increase the viscosity of hydrogel according to claim 1.

19. The method of claim 18, wherein the hydrogel is formed by using a solution of copolymer according to claim 1, either by dissolving a polymer gel from a gel-polymerization or from a solution polymerization in water containing dissolved alkali metal salt, earth alkali metal salt and/or organic amine salt or by inverting an inverse polymer emulsion in water containing dissolved alkali metal salt, earth alkali metal salt and/or organic amine salt, by optionally adding a buffer, further additives and/or proppants, and by adding a zirconium salt solution or a zirconium complex solution prior to the injection into the reservoir resulting in the formation of a hydrogel which is then injected into the reservoir or which forms during injection.

20. The method of claim 18, wherein in a first step an aqueous solution of the copolymer in a higher concentration as needed in the final hydrogel product is produced which comprises no dissolved salt or a low content of dissolved salt and in a second step to this solution an aqueous solution comprising dissolved salt in a higher concentration is added so that the desired concentrations of copolymer and dissolved salt are obtained and then the copolymer is crosslinked by adding a Zr-compound to the solution to form the final hydrogel product.

21. The method of claim 18, wherein the aqueous solution containing dissolved salt is a solution of water containing dissolved alkali metal salt and/or earth alkali metal salt and which is saline water, sea water, formation water or produced water.

22-24. (canceled)
